(19) United States
(12) Patent Application Publication
(10) Pub. No.: US 2014/0172269 A1
(43) Pub. Date: Jun. 19, 2014

(54) Dual-Mode Cryogenic LNG Piston Pump Control Strategy

(71) Applicant: CATERPILLAR INC., Peoria, IL (US)

(72) Inventor: Toby Perry, Minooka, IL (US)

(73) Assignee: Caterpillar Inc., Peoria, IL (US)

(21) Appl. No.: 13/717,259

(22) Filed: Dec. 17, 2012

(51) Int. Cl. F02D 41/00

(52) U.S. Cl. CPC F02D 41/0025
USPC 701/102; 123/495

(57) ABSTRACT

A control strategy for a cryogenic LNG piston pump and method of operation same are disclosed. The piston pump may employ a bifurcated control strategy based on the operating speed of an engine to which the pump is providing fuel. More specifically, at engine idle speed, the control strategy may employ a first control strategy split wherein a compression stage and a suction stage of the pump are conducted at a first ratio. At engine rated speed, the control strategy may employ a second split wherein the compression stage and suction stage are conducted at a second ration, wherein the second ratio is different from the first ratio.

### FIELD OF THE DISCLOSURE

The present disclosure generally relates to pumps and, more particularly, relates to liquid natural gas (LNG) cryogenic pumps.

### BACKGROUND OF THE DISCLOSURE

It has become increasingly common for many work machines used in agricultural, construction and mining operations to be powered by alternative fuels. Such machines, which may be provided in many forms such as front-end loaders, track-type tractors, excavators, pipe layers, graders and the like, have traditionally been powered by diesel fuel, which to this day is still the most common fuel source. However, due to environmental concerns, cost and availability, other fuels such as, but not limited to, natural gas, have been utilized. Such natural gas can be provided in many forms including methane.

In order to provide the natural gas to the engine in a portable, efficient manner, the natural gas is cooled to a liquid state and stored on-board the machine in a cryogenic tank. Such tanks are typically double-hulled with insulation between the hulls in order to maintain the natural gas at temperatures at least as low as −160° C., and at pressures of at least as high as 300 psi. A pump is then used to deliver the LNG to the engine of the machine. Such pumps are typically provided as piston pumps which not only deliver the LNG to the engine but also pressurize same to convert the LNG to compressed natural gas (CNG). For example, whereas LNG is typically at the aforementioned pressure of about 300 psi, CNG is typically ten times that, or about 3000 psi.

Such a piston pump, also referred to as a cryogenic pump, often consists of a single piston reciprocatingly mounted in a cylinder. In order to move the piston back and forth in the cylinder, and thus draw in (suction stroke) and then compress (compression stroke) the natural gas, hydraulic fluid is utilized. More specifically, hydraulic fluid is directed to a retraction port in the piston pump, while hydraulic fluid is expelled from an extension port when the suction stroke is conducted. Conversely, when the compression stroke is conducted, hydraulic fluid is directed to the extension port, while hydraulic fluid is released from the retraction port. An example of this technology is disclosed in Canadian Patent No. 2,523,732.

In order to provide the hydraulic fluid, one or more hydraulic pumps are typically provided on the machine and driven by the engine of the machine. Such pumps can be provided in a number of different forms, with variable displacement piston pumps being one common example. With a variable displacement piston pump, a central barrel or block is rotatably driven by the engine. The barrel includes a plurality of cylinders each of which is adapted to receive a reciprocating piston. At a driven end, each of the pistons is pivotally and slidably engaged with a swashplate angularly positioned relative to the cylinder barrel. At a work end of each cylinder, a valve plate is provided having two or more kidney-shaped inlets and outlets. During the inlet phase of operation, hydraulic fluid is drawn in through the inlet of the valve plate, and into the cylinders of the rotating barrel. This drawing in or filling of the cylinders occurs as the barrel rotates, and the pistons of the barrel proximate to the inlet move from a top dead center position to bottom dead center position. The rotation of the barrel and size of the inlets are such that once the piston reaches its bottom dead center position, the cylinders rotate out of communication with the inlet of the valve plate. Further rotation of the barrel causes the cylinders, now completely filled with hydraulic fluid, to create fluid flow as the pistons move from the bottom dead center position to the top dead center position. During travel from the bottom dead center to the top dead center position, the cylinders are placed into communication with the outlet of the valve plate such that the hydraulic fluid can be delivered from the pump to provide for useful work such as the aforementioned driving of implements and work arms provided on various earth moving equipment.

While effective, in certain situations this may be inefficient. For example, with current liquefied natural gas (LNG) cryogenic piston pumps, regardless of whether the engine employing the pump is idling, current controls provide a quick compression stroke and relatively long suction stroke. As such quick compression stroke require significant hydraulic fluid flow from the hydraulic pump, this burdens the engine even when at idle. This results in higher torque at idle than is needed, higher load on the engine at idle than is needed, a larger overall pump size than is needed, and lower fuel economy.

### SUMMARY OF THE DISCLOSURE

In accordance with one aspect of the disclosure, a method of operating a cryogenic piston pump for use in supplying fuel to an engine is disclosed. The method may comprise determining the actual speed of the engine, operating the cryogenic piston pump under a first control strategy when the engine is at an idle speed, and operating the variable displacement piston pump under a second control strategy when the engine is at a rated speed, with the second control strategy being different from the first control strategy.

In accordance with another aspect of the disclosure, a liquefied natural gas pump control system is disclosed which may comprise a source of liquefied natural gas, a cryogenic piston pump operatively connected to the source of liquefied natural gas, an engine receiving compressed natural gas from the cryogenic piston pump, and an electronic control module commanding the cryogenic piston pump to operate in at least two different modes depending on the speed at which the engine is operating.

In accordance with another aspect of the disclosure, a machine is disclosed which may comprise a chassis, an engine supported by the chassis, a locomotion device supporting the chassis, a hydraulic cylinder operatively associated with the machine, a fuel source supported by the chassis, a fuel pump interconnecting the fuel source and the engine, and an electronic control module operatively connected to the engine and the fuel pump and commanding the fuel pump to operate in at least two different modes depending on an operating parameter of the engine.

These and other aspects and features of the present disclosure will become more readily apparent upon reading the following detailed description when read in light of the accompanying drawings.

### BRIEF DESCRIPTION OF THE DRAWINGS

FIG. 1 is a perspective view of a machine constructed in accordance with the teachings of the disclosure;

FIG. 2 is a schematic representation of a liquid natural gas (LNG) and diesel delivery system for a machine employing the teachings of the present disclosure; and

FIG. 3 is a sectional view of cryogenic LNG pump in a suction stroke;

FIG. 4 is a sectional view of the cryogenic pump in a compression stroke; and

FIG. 5 is a sectional view of a hydraulic fluid pump constructed in accordance with the present disclosure;

FIG. 6 is a flowchart depicting a sample sequence of steps that may be practiced in accordance with the teachings of this disclosure.

### DETAILED DESCRIPTION

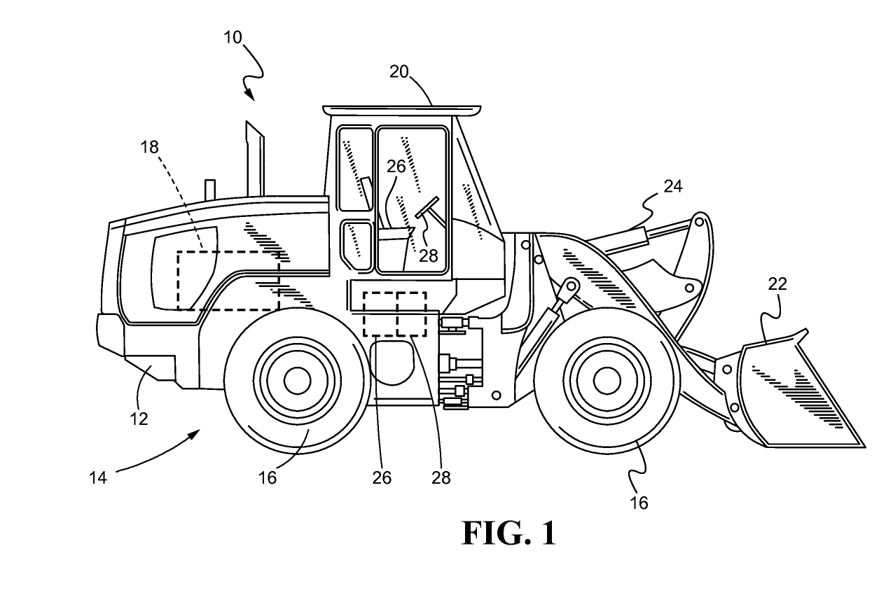

Referring now to the drawings, and with specific reference to FIG. 1, a machine 10 constructed in accordance with the teachings of the disclosure is shown in detail. Although the machine 10 depicted in FIG. 1 is that of a wheeled loader, it is to be understood that the teachings of the disclosure can find equal applicability in connection with many other earth moving machines such as, but not limited to, track-type tractors, excavators, motor graders, pipe layers, dump trucks, articulated trucks, and the like.

As shown therein, the machine 10 may include a chassis 12 supported by a locomotion device 14. While the locomotion device 14 depicted in FIG. 1 is that of a plurality of wheels 16, any number of different other locomotion devices 14 can be used such as, but not limited to, continuous tracks. The chassis 12 may support an engine 18 as well as an operator cabin 20. The engine 18 can be provided in any number of different forms including internal combustion engines such as diesel engines and otto cycle engines. In addition, the engine 18 may be adapted to run on diesel fuel or other fuels such as, but not limited to, liquefied natural gas (LNG). As used herein, LNG generally refers to liquefied natural gas such as, but not limited to, methane, but other types of natural gas are certainly possible as well.

Extending from the chassis 12, the machine may include one or more work implements 22 adapted for movement relative to the chassis 12 by a plurality of hydraulic cylinders 24. While the work implement 22 is depicted as a bucket in FIG. 1, it is to be understood that any other number of other work implements including, but not limited to, tines, augers, brushes, forks, shovels and the like are certainly possible. As indicated above, the engine 18 may be adapted to operate in part using liquid natural gas as its fuel. Accordingly, a source of liquid natural gas such as LNG tank 26 may be provided onboard machine 10. A separate diesel fuel tank 28 may also be provided.

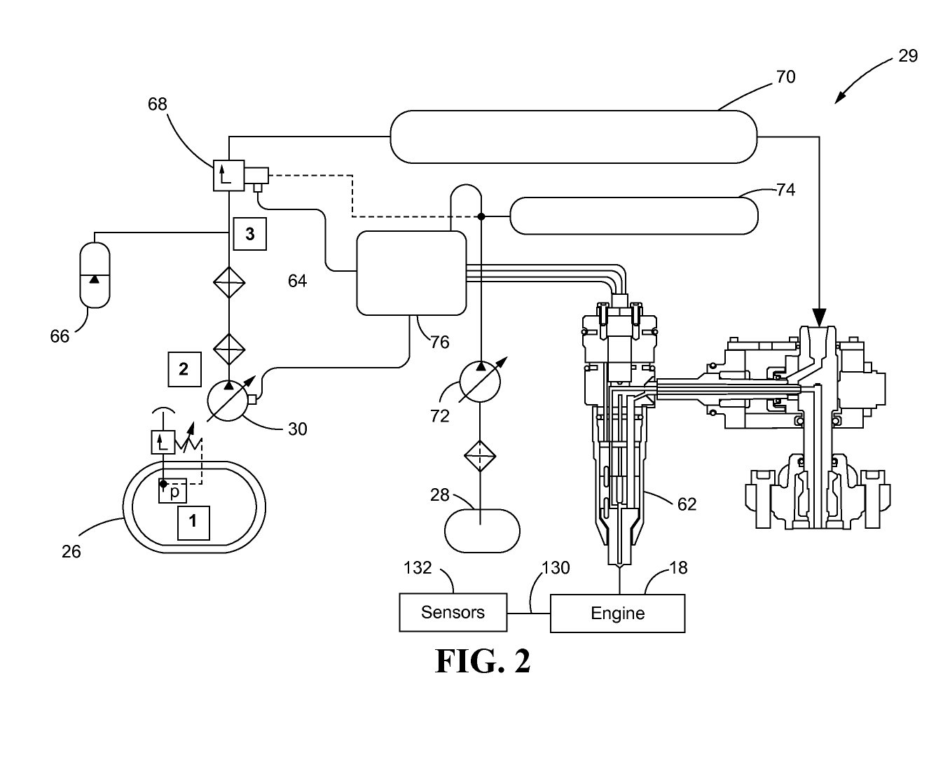

Referring now to FIG. 2, an overall fuel delivery system 29 for the machine 10 is depicted. As shown therein, a LNG cryogenic piston pump 30 may be in fluid communication with the LNG tank 26 for delivery of LNG to a fuel injector 62. The LNG tank 26 may be a cryogenic tank adapted to store the LNG at temperatures as low as −160° C., for example. The system 29 may further include a heat exchanger 64 to convert the LNG from LNG to CNG (compressed natural gas), and an accumulator 66 to store the added volume generated after the conversion and serve as a reservoir to ensure adequate pressure is always available. A pressure control valve 68 may be disposed downstream of the heat exchanger 64 prior to provision of the gas to a CNG rail or manifold 70. From the manifold 70, the gas is distributed to one of more of the aforementioned fuel injectors 62. To complete the structure forming the system 29, as the engine 18 may be powered by either LNG or diesel fuel, the system 29 further includes the diesel fuel tank 28, diesel fuel pump 72, and diesel fuel rail or manifold 74 for distribution of diesel fuel to the fuel injectors 62. An electronic control module (ECM) 76 is provided to control operation of LNG pump 30, valve 68 and diesel fuel pump 72 as will now be described.

As noted above, the LNG pump 30 may be called upon to deliver a variable volume of LNG depending upon the speed at which the engine 18 is operating. For example, if the machine 10 is engaged in digging, loading, or in otherwise using its work implement, the engine 18 will be operating at a rated speed, whereas if the machine 10 is not performing useful work and is simply idling, the engine 18 will be working at a lower idle speed. Of course at the higher rated speed, the engine will be requiring more fuel and at the lower idle speed, the engine will be requiring less fuel. This, in turn, requires that the variable displacement fuel pump 30 provide more or less fuel as dictated by the speed of the engine 18. Other engine parameters can certainly be used to dictate the amount of fuel being supplied by the fuel pump.

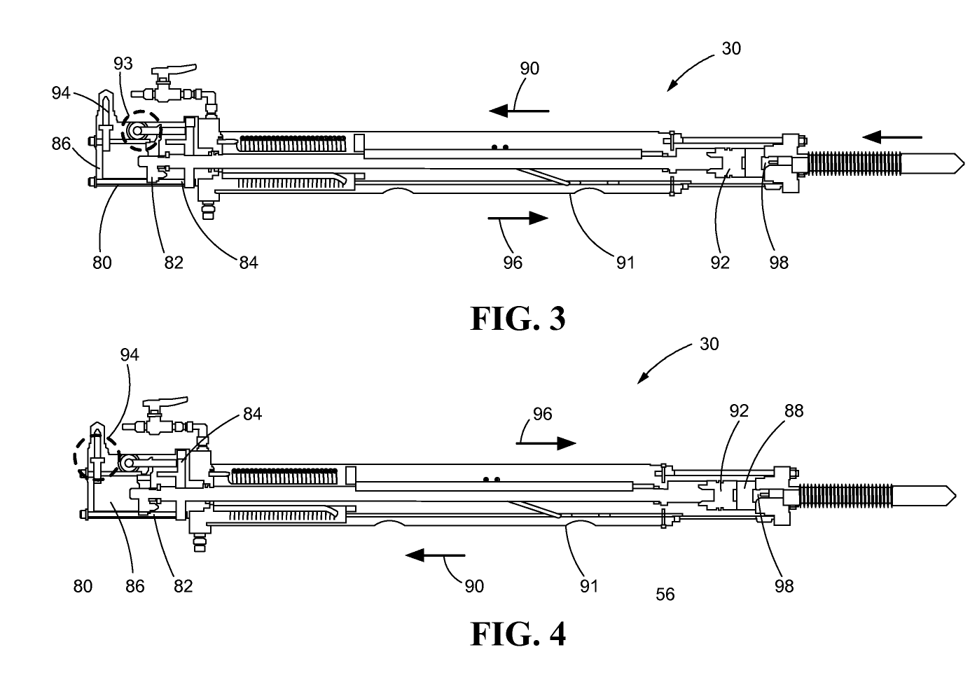

In order to supply the LNG, the pump 30 may be provided as a piston pump such as shown in FIGS. 3 and 4. As shown therein, the piston pump 30 may include a cylinder 80 in which a piston 82 is adapted to reciprocate. The piston 82 so reciprocates by way of introduction and expulsion of hydraulic fluid into retraction chamber 84 and extension chamber 86. More specifically, if a suction stroke is being conducted (as shown in FIG. 3) and it is thus desired to draw LNG into pumping chamber 88, piston 82 needs to retract in the direction of arrow 90. In so doing, piston 82 moves rod 91 in the same direction. Rod 91 in turn pulls plunger 92 in the direction of arrow 90 thereby drawing LNG into the pumping chamber 88. To do so, hydraulic fluid is directed to the retraction chamber 84 through retraction port 93, while hydraulic fluid is expelled from the extension chamber 86 through extension port 94. Conversely, when a compression stroke is being conducted (as shown in FIG. 4) and it is desired to compress the LNG and thereby deliver CNG to the engine 18, piston 82 needs to extend in the direction of arrow 96. To do so, hydraulic fluid is directed into the extension chamber 86 through the extension port 94, and hydraulic fluid is expelled from the retraction chamber 84 through the retraction port 92. This in turn drives piston 82 and rod 91 in the direction of arrow 96. In so doing, plunger 92 is moved in the direction of arrow 96 and LNG is expelled from the pumping chamber 88. A one-way check valve 98 may be provided to ensure the LNG is not redirected back out of the pumping chamber 88 toward the tank 26.

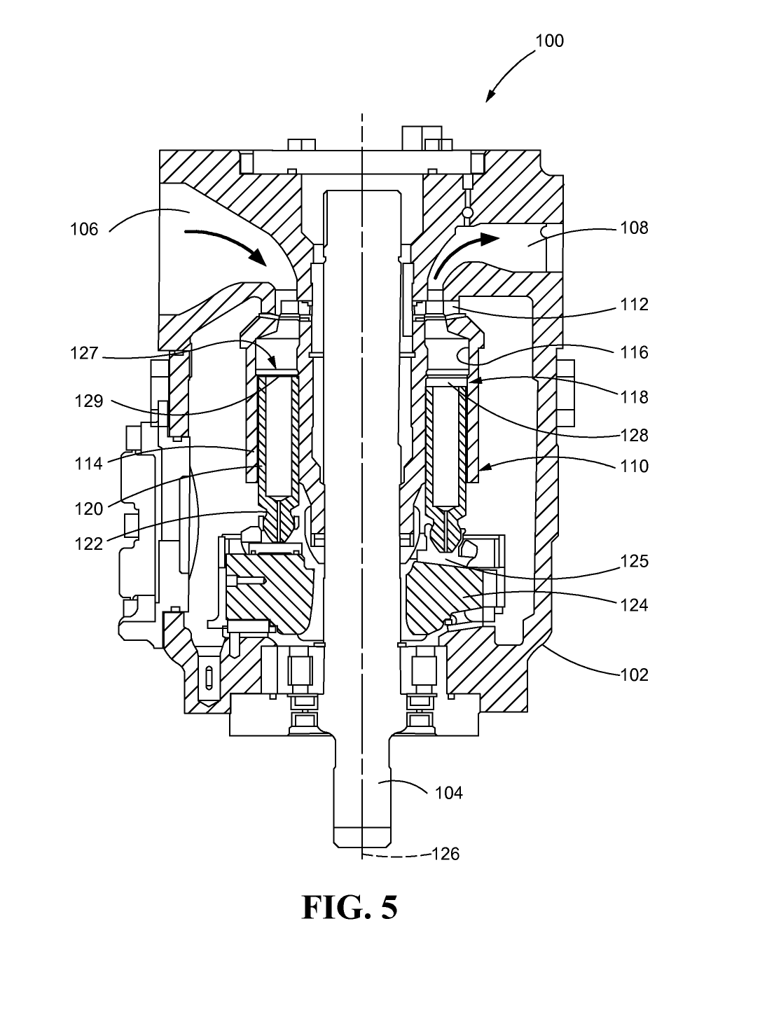

In order to provide that hydraulic fluid, a hydraulic pump 100 such as that depicted in FIG. 5 may be utilized. Of course, any form of pump may be used to deliver the hydraulic fluid, with hydraulic pump 100 being but one example. As shown therein, the pump 100 includes an exterior housing 102 from which extends a drive shaft 104. The pump 100 is designed to draw fluid, such as hydraulic fluid, in through inlet 106 and out through outlet 108 for communication to the LNG cryogenic piston pump 30. The drive shaft 104 is operatively connected to a barrel 110 adapted to rotate within the housing 102. The barrel 110 is positioned next to a valve plate 112 which itself is in fluid communication with the aforementioned inlet 106 and outlet 108. The barrel 110 may include a block 114 in which are machined a plurality of cylinders 116. Each cylinder 116 is parallel and includes a cylinder wall 118. A piston 120 is reciprocatingly mounted within each of the cylinders 116. More specifically, each piston 120 is adapted to reciprocate within the cylinders 116 as the pistons 120 and cylinder barrel 110 rotate around the pump 100 through inlet and outlet strokes.

In order to reciprocate the pistons 120 through the cylinders 116, a driven end 122 of each piston is rotatably and slideably engaged with a swashplate 124 by way of a shoe 125. As will be noted, the swashplate 124 can be provided at a transverse angle relative to the cylinder barrel 110 such as that as the barrel 110 and pistons 120 rotate about longitudinal axis 126 under the influence of hydraulic fluid entering and exiting the cylinders 116, the pistons 120 are caused to reciprocate back and forth therein. Moreover, the angle at which the swashplate 124 is positioned necessarily dictates the resulting volume of fluid flow from the pump 100. For example, if the swashplate 124 is parallel to the valve plate 112, then there would be no flow of fluid at all. However, with each degree the swashplate 124 is pivoted away from parallel, the resulting flow of the expelled fluid is increased.

Opposite to the driven end 122, each piston 120 includes a working end 127. Also shown in FIG. 2, the working end 127 is adapted to reciprocate between a bottom dead center position 128, and a top dead center position 129. As one of the ordinary skill in the art will understand, during the filling or intake stroke of each piston 120, the working end 127 moves from the top dead center position 129 to the bottom dead center position 128; and during the exhaust stroke, the working end 127 moves from a bottom dead center position 128 to the top dead center position 129.

### INDUSTRIAL APPLICABILITY

With prior art devices, the LNG pump 30 is simply operated in one manner regardless of the mode in which the machine 10 is operating. By necessity, this required the pump 30 to operate at its higher speed so as to be able to provide the necessary fuel when the machine 10 was performing useful work. This in turn meant that the LNG pump 30 and overall machine 10 were operating inefficiently when at idle speed.

In light of this, the present disclosure significantly improves upon the teachings of the prior art and allows for the LNG pump 30 to be operated in a bifurcated fashion. More specifically, the present disclosure sets forth the LNG and diesel fuel delivery system 60 of FIG. 3 having the electronic control module 76 to operate the system 60 in at least two different modes. In a first mode, referred to herein as rated speed mode, the electronic control module 76 receives signals 130 from engine 18 indicating that the engine 18 is operating at a rated speed. This will most likely be due to the machine 10 performing useful work. The signals 130 may be provided by way of sensors 132 in the form of a tachometer to measure the revolutions per minute (rpm) of the engine 18 or the like. Similarly, if the sensors 132 determine that the engine 18 is operating at an idle speed, signals 130 will so indicate and in turn the electronic control module 76 will command the system to operate at an idle speed mode. As used herein, a rated speed for engine 18 may be anywhere from 900 to 1800 rpm, whereas the idle speed may be 700 or less rpm. Other RPM ranges are certainly possible.

A significance of the two modes of operation manifests itself in enabling the engine 18 to operate at a much lesser load at idle in that, when idling, it is not necessary to have the cryogenic pump 30 provide a quick compression cycle which necessarily uses more hydraulic oil flow from the hydraulic fluid pump 100. At idle, a significantly lesser amount or even no torque is required than at rated speed. A second benefit is reduced hydraulic pump size. By altering the control strategy, the cryogenic pump 30 can be used to its fullest and most efficient capacity at both idle and rated speeds. If the control strategies were the same, as is the case with the prior art, the hydraulic pump 100 would necessarily have to be oversized so as to accommodate the idle condition, or conversely, underutilized in the rated condition. These two benefits also result in a reduced component cost and fuel savings.

As this applies to one specific embodiment of the actual operation of the machine 10, in the rated speed mode, i.e. when the sensors 132 determine that the engine 18 is operating at a rated speed or within the rated speed range, the electronic control module 76 will command the hydraulic fluid pump 100 to operate in a manner wherein some percentage (for example 25%) of the LNG cryogenic piston pump 30 cycle time is spent in compression strokes, and some other percentage (for example 75%) of the LNG cryogenic piston pump 30 operation cycle is spent in a suction stroke. Of course, 25% and 75% are but one example, and the teachings of this disclosure allow for an infinitely variable range between 0 and 100% for either stroke/cycle. This allows for the LNG cryogenic piston pump 30 to more easily keep pace with the fuel demands of the engine when it is performing useful work. In other words, when the engine 18 is being called upon by the work implements 22 to perform useful work, a larger volume of fuel is required, and thus more time is spent by the LNG pump 30 in drawing fuel from the tank 26 and directing same to the engine 18, as opposed to compressing same.

Conversely, when the sensors 132 determine that the engine 18 is working at an idle speed, the idle speed mode of the LNG pump 30 allows the electronic control module 76 to operate the LNG pump 30 but with more time in compression strokes, and less time in suction strokes. For example, at idle speed, the electronic control module may dictate that the LNG cryogenic pistonpump 30 split time evenly, i.e. with 50% of the fuel pump operating cycle being in compression strokes, and 50% being in suction strokes. Again, while the 50/50 split is indicated herein for such an idle condition, it is to be understood that any number of other different percentages may be employed and still fall within the range of equivalents the present disclosure. What is of importance is that some form of a bifurcated control strategy is used to more efficiently operate the LNG pump 30 depending on the needs of the engine 18. In so doing, idle torque can be reduced and pump utilization can be tailored to its most efficient extent in both idle and rated speeds. Moreover, in so doing, the overall size of the hydraulic pump 100 can be reduced, and thus component cost can be reduced and fuel economy of the machine 10 can be increased.

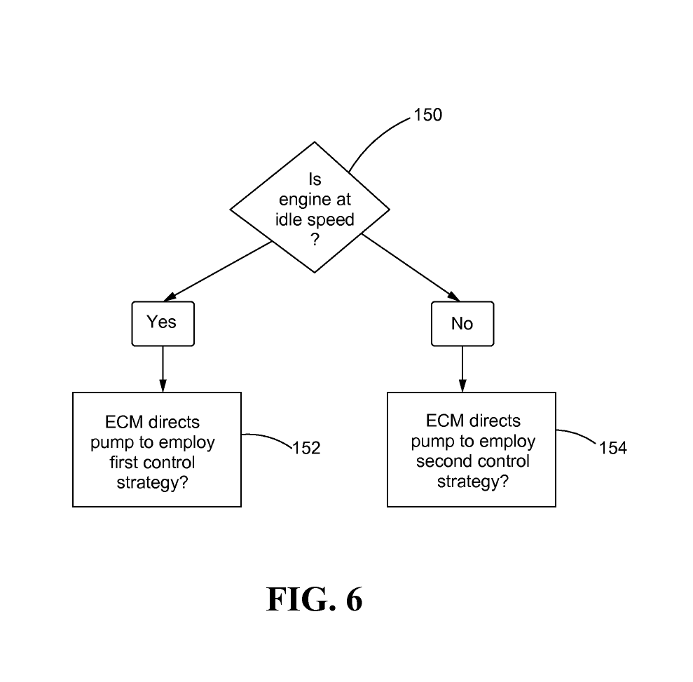

Referring now to FIG. 6, a flowchart depicting a sample sequence of steps that may be practiced in accordance with the teachings of this disclosure by the ECM 76 is shown. Starting with a step 150, the ECM 76 determines if the engine 18 is at idle speed. This speed may vary depending on the design of the engine and machine employing the engine, but may be, for example, about 700 rpm. If step 100 determines the engine 18 is at idle speed, the ECM 76 directs the hydraulic fluid pump 100 to employ a first control strategy wherein 50% (or other) of the LNG cryogenic piston pump 30 operation is in a compression stroke, and 50% (or other) of the LNG cryogenic piston pump 30 operation is in a suction stroke as indicated by step 152. However, if step 150 determines the engine 10 is at rated speed, the ECM 76 directs the hydraulic fluid pump 100 to employ a second control strategy wherein 25% (or other) of the LNG cryogenic piston pump 30 operation is in a compression stroke, and 75% (or other) of the LNG cryogenic piston pump 30 operation is in a suction stroke as indicated by a step 154. Again, these percentages may vary from engine to engine and machine to machine depending on the given application.

From the foregoing, it can be seen that the technology disclosed herein has industrial applicability in a variety of settings such as, but not limited to, engine control strategies. Such engines may be diesel engines or hybrid engines employing both diesel fuel and liquefied natural gas and used on earth-moving equipment, or highway trucks, or the like. By providing dual modes of operation, significant gains in efficiency and cost reduction can be achieved.

More specifically, a first benefit is reduced engine load at idle. When idling, it is not necessary to provide a quick compression cycle, which uses more hydraulic oil flow. If a single control strategy were to be employed, the torque required at idle would be significantly higher than that required at rated speed. A second benefit is reduced hydraulic pump size. By altering the control strategy, the pump can be utilized to its fullest at both idle and rated speeds. If the control strategies were the same, the pump would be under-utilized in the rated condition. These two benefits result in reduced component costs and fuel savings.

What is claimed is:

1. A method of operating a cryogenic piston pump for use in supplying LNG to an engine, comprising:
determining the actual speed of the engine;
operating the cryogenic piston pump under a first control strategy when the engine is at an idle speed; and
operating the cryogenic piston pump under a second control strategy when the engine is at a rated speed, the second control strategy being different than the first control strategy.

2. The method of claim 1, wherein the first control strategy causes the cryogenic piston pump to operate 50% of its cycle in a compression stage, and 50% of its cycle in a suction stage.

3. The method of claim 1, wherein the second control strategy causes the cryogenic piston pump to operate in a suction stage at a greater percentage of cycle time than in a compression stage.

4. The method of claim 1, wherein the engine operates solely on diesel fuel.

5. The method of claim 1, wherein the engine operates on both diesel fuel and liquefied natural gas.

6. The method of claim 1, wherein the engine idle speed is less than the engine rated speed.

7. A liquefied natural gas pump control system, comprising:
a source of liquid natural gas;
a cryogenic piston pump operatively connected to the source of liquid natural gas;
an engine receiving compressed natural gas from the cryogenic piston pump; and
an electronic control module commanding the cryogenic piston pump to operate in at least two different modes depending on the speed at which the engine is operating.

8. The fuel pump control system of claim 7, wherein the engine is adapted to operate on both liquefied natural gas and diesel fuel.

9. The fuel pump control system of claim 7, further including a hydraulic fluid pump in fluid communication with the cryogenic piston pump.

10. The fuel pump control system of claim 7, wherein the at least two different modes of operation of the cryogenic piston pump includes a rated speed mode wherein when the engine is operating at a rated speed, the electronic control module commands the cryogenic piston pump to operate in a compression cycle for less time than a suction cycle.

11. The fuel pump control system of claim 10, wherein the at least two different modes of operation of the cryogenic piston pump further includes an idle speed mode wherein when the engine is operating at an idle speed, the electronic control module commands the cryogenic piston pump to split pump operation into 50% compression cycle time and 50% suction cycle time.

12. The fuel pump control system of claim 7 wherein the electronic control module is infinitely variable to command the cryogenic pump to operate with a suction cycle time between 0 and 100%.

13. A machine, comprising:
a chassis;
an engine supported by the chassis;
a locomotion device supporting the chassis;
a hydraulic cylinder operatively associated with the machine;
a fuel source supported by the chassis;
a fuel pump interconnecting the fuel source and the engine; and
an electronic control module operatively connected to the engine and the fuel pump and commanding the fuel pump to operate in at least two different modes depending on an operating parameter of the engine.

14. The machine of claim 13, wherein the fuel source contains liquefied natural gas.

15. The machine of claim 13, further including a hydraulic fluid pump in fluid communication with the fuel pump.

16. The machine of claim 13, wherein the machine is an earth-moving machine.

17. The machine of claim 13, wherein the fuel pump is a cryogenic piston pump.

18. The machine of claim 13, wherein the operating parameter of the engine is engine speed.

19. The machine of claim 18, wherein the at least two modes of operation of the fuel pump includes an idle speed mode wherein, when the engine is operating at an idle speed, the electronic control module commands the fuel pump to split pump operation into 50% compression cycle time and 50% suction cycle time.

20. The machine of claim 19, wherein the at least two modes of operation of the fuel pump further includes a rated speed mode wherein, when the engine is operating at a rated speed, the electronic control module commands the fuel pump to split pump operation into a compression cycle time which is less than a suction cycle time.
